(19) United States
(12) Patent Application Publication
(10) Pub. No.: US 2016/0050707 A1
(43) Pub. Date: Feb. 18, 2016

(54) METHOD AND APPARATUS FOR DATA RADIO BEARER CONFIGURATION IN A HETEROGENEOUS NETWORK

(71) Applicant: NOKIA CORPORATION, Espoo (FI)

(72) Inventors: Haitao LI, Beijing (CN); Yang LIU, Beijing (CN); Benoist SÉBIRE, Tokyo (JP)

(21) Appl. No.: 14/778,885

(22) PCT Filed: Apr. 2, 2013
(86) PCT No.: PCT/CN2013/073671

§ 371 Date: Sep. 21, 2015

(51) Int. Cl. H04W 76/02; H04W 36/04; H04W 72/04

(52) U.S. Cl. CPC H04W 76/025; H04W 72/04; H04W 36/04; H04W 88/06

(57) ABSTRACT

In accordance with an example embodiment of the present invention, an apparatus comprising: at least one processor; and at least one memory including computer program code, wherein the at least one memory and the computer program code are configured to, with the at least one processor, cause the apparatus to perform at least the following: receive information on data radio bearer transmission configuration from a primary serving cell or a secondary serving cell which indicates configuration of data radio bearer transmission in at least one serving cell; and transmit data according to the configuration.

### TECHNICAL FIELD

The present application relates generally to data radio bearer configuration for dual connectivity to both macro cell layer and small cell layer in a heterogeneous network.

### BACKGROUND

Various abbreviations that appear in the specification and/or in the drawing figures are defined as below:
CA Carrier Aggregation
DRB Data Radio Bearer
eNB evolved Node B
PCell Primary Cell
PDCCH Physical Dedicated Control CHannel
QoS Quality of Service
RRC Radio Resource Control
Scell Secondary Cell
UE User Equipment

Dual connectivity to both macro cell layer and small cell layer can bring many benefits to a UE, such as increased data rate, robust mobility control, and so on. Network can also benefit from it in terms of flexible offloading and load balancing. To model dual connectivity, inter-site CA, or inter-eNB CA, is one of the feasible options. For inter-site CA with macro eNB and small cell eNB physically located in separate sites, UE sees one RRC entity which is responsible for signalling all radio resources configurations in macro layer and small cell layer to the UE. Typically primary serving cell is managed on a macro cell layer and secondary serving cells are managed on a small cell layer. This is because macro cell has relatively large coverage and more coordinated deployment as compared to the small cells, therefore it is more suitable to maintain and manage UE's network connection with less frequent cell change or handover encountered during UE's mobility. Besides inter-site CA, dual RRC is another option for modeling dual connectivity. With dual RRC, the UE sees two distinct RRC entities: one in the small cell and one in the macro cell. The small cell is then able to signal some radio resources configurations directly to the UE. This would however still require some coordination with the macro eNB for instance to make sure that the UE capability are not exceeded. A DRB is established for each logical channel. And a DRB transmission may be configured for one or more serving cells.

### SUMMARY

Various aspects of examples of the invention are set out in the claims.

According to a first aspect of the present invention, an apparatus comprising: at least one processor; and at least one memory including computer program code, wherein the at least one memory and the computer program code are configured to, with the at least one processor, cause the apparatus to perform at least the following: receive information on data radio bearer transmission configuration from a primary serving cell or a secondary serving cell which indicates configuration of data radio bearer transmission in at least one serving cell; and transmit data according to the configuration.

According to a second aspect of the present invention, a method comprising: receiving information on data radio bearer transmission configuration from a primary serving cell or a secondary serving cell which indicates configuration of data radio bearer transmission in at least one serving cell; and transmitting data according to the configuration.

According to a third aspect of the present invention, a computer program product comprising a computer-readable medium bearing computer program code embodied therein for use with a computer, the computer program code comprising: code for receiving information on data radio bearer transmission configuration from a primary serving cell or a secondary serving cell which indicates configuration of data radio bearer transmission in at least one serving cell; and code for transmitting data according to the configuration.

According to a fourth aspect of the present invention, an apparatus comprising: at least one processor; and at least one memory including computer program code, wherein the at least one memory and the computer program code are configured to, with the at least one processor, cause the apparatus to perform at least the following: configure data radio bearer transmission for at least one serving cell; and transmit information on the data radio bearer transmission configuration to a user equipment.

According to a fifth aspect of the present invention, an apparatus comprising: means for receiving information on data radio bearer transmission configuration from a primary serving cell or a secondary serving cell which indicates configuration of data radio bearer transmission in at least one serving cell; and means for transmitting data according to the configuration.

According to a sixth aspect of the present invention, an apparatus comprising: means for configuring data radio bearer transmission for at least one serving cell; and means for transmitting information on the data radio bearer transmission configuration to a user equipment.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an exemplary heterogeneous network in which the example embodiments of the present invention may be practiced;

FIG. 2 illustrates a block diagram of an apparatus in accordance with an example embodiment of the invention;

FIG. 3 is a flow chart illustrating an example method for data radio bearer configuration in a heterogeneous network in accordance with an example embodiment of the invention; and

FIG. 4 is a flow chart illustrating an example method for data radio bearer configuration in a heterogeneous network in accordance with another example embodiment of the invention.

### DETAILED DESCRIPTION OF THE DRAWINGS

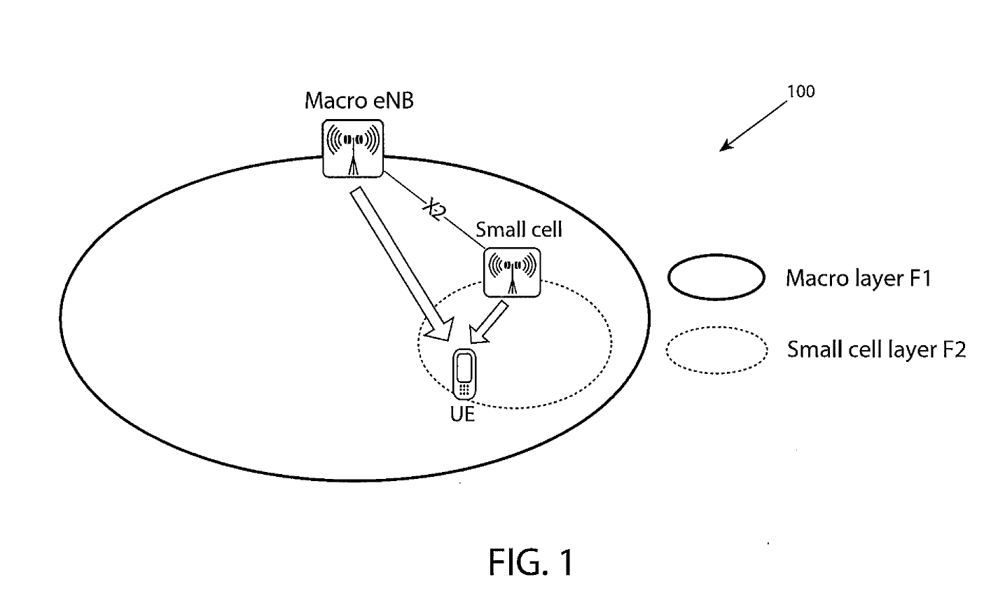

An example embodiment of the present invention and its potential advantages are understood by referring to FIGS. 1 through 4 of the drawings.

FIG. 1 illustrates an exemplary heterogeneous network 100 in which the example embodiments of the present invention may be practiced. As illustrated in FIG. 1, in the heterogeneous network (“HetNet” for short) 100, a UE is in connection with a macro eNB and a small cell eNB, i.e., in a dual connectivity mode. The coverage areas of the eNBs are depicted by ellipses of different sizes, wherein the coverage area of the macro eNB is much larger than that of the small cell eNB and overlays the coverage area of the small cell eNB. The macro eNB is in connection with the small cell eNB via an open (e.g. X2) interface over non-ideal backhaul. It should be noted that only one secondary cell is shown for a simplified purpose and there may exist multiple secondary cells under the coverage area of the macro eNB or small cell eNB and thus may provide component carriers F3, F4, F5, . . . , for UE's measurement, mobility decision-making and CA.

In the dual connectivity mode, if the CA is supported, the UE may be served by multiple cells over different component carriers of one or two eNBs. For example, as shown in FIG. 1, the UE is served by the macro eNB (i.e., primary serving cell (PCell)) over a primary component carrier F1. The UE is also served by the small cell eNB (i.e., secondary serving cell (SCell)) over secondary component carrier F2.

In the HetNet scenario as depicted in FIG. 1, wireless service operators, if owning plenty of spectrum, usually deploy a set of macro frequencies and a set of small cell frequencies (e.g., F1 and F2 as illustratively depicted). Such kind of deployment can eliminate the need of co-channel interference/cancellation between small cells and macro cells, and can also facilitate high end-user throughput by utilizing dual connectivity simultaneously, e.g. by performing inter-site CA. In the inter-site CA, UE's movement among small cells leads to SCell mobility. Such SCell mobility usually does not have impact on PCell as long as UE is moving within the coverage area of the same macro cell (i.e., PCell), e.g., the bigger ellipse as depicted in FIG. 1. SCell mobility, or more specifically referred to as SCell replacement, is important for maintaining UE's data rate and end user's experience. Fast SCell replacement is always required to avoid data rate degradation or even data interruption.

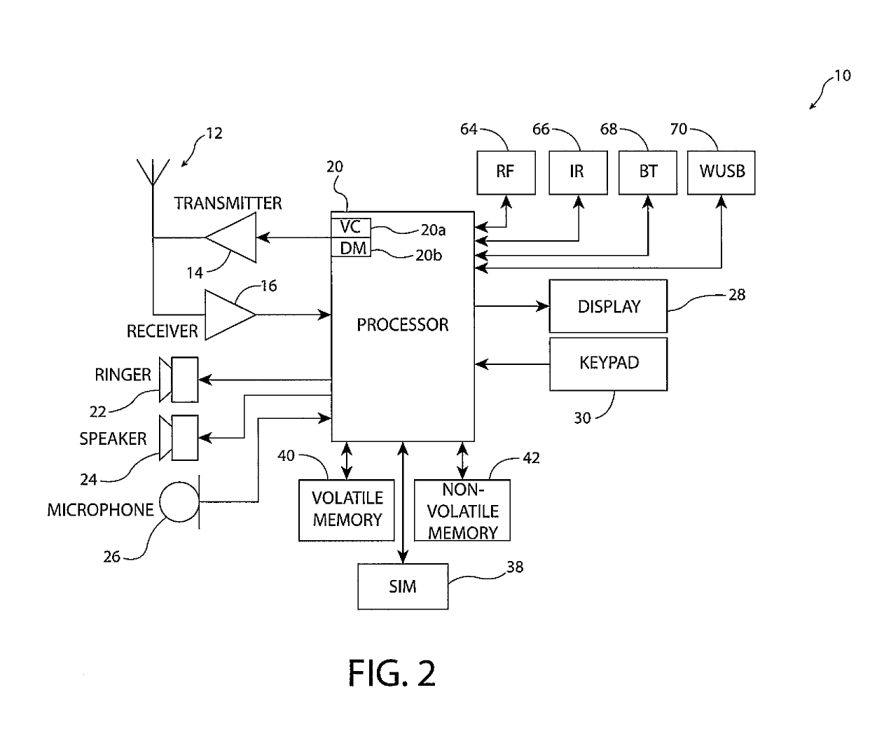

FIG. 2 illustrates a block diagram of an apparatus 10 such as, for example, a mobile terminal, in accordance with an example embodiment of the invention. While several features of the apparatus are illustrated and will be hereinafter described for purposes of example, other types of electronic devices, such as mobile telephones, mobile computers, portable digital assistants, PDAs, pagers, laptop computers, desktop computers, gaming devices, televisions, routers, home gateways, and other types of electronic systems, may employ various embodiments of the invention.

As shown, the mobile terminal 10 may include at least one antenna 12 in communication with a transmitter 14 and a receiver 16. Alternatively transmit and receive antennas may be separate. The mobile terminal 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 2 as a single processor, in some embodiments the processor 20 comprises a plurality of processors or processing cores. Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future.

Some Narrow-band Advanced Mobile Phone System, NAMPS, as well as Total Access Communication System, TACS, mobile terminal apparatuses may also benefit from embodiments of this invention, as should dual or higher mode phone apparatuses, for example, digital/analog or TDMA/CDMA/analog phones. Additionally, apparatus 10 may be capable of operating according to Wi-Fi or Worldwide Interoperability for Microwave Access, WiMAX, protocols.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder, VC, 20a, an internal data modem, DM, 20b, and/or the like. Further, the processor may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the mobile terminal 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus may comprise a battery for powering various circuits related to the mobile terminal, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 2, apparatus 10 may also include one or more means for sharing and/or obtaining data. For example, the apparatus may comprise a short-range radio frequency, RF, transceiver and/or interrogator 64 so data may be shared with and/or obtained from electronic devices in accordance with RF techniques. The apparatus may comprise other short-range transceivers, such as, for example, an infrared, IR, transceiver 66, a Bluetooth™ BT, transceiver 68 operating using Bluetooth™ brand wireless technology developed by the Bluetooth™ Special Interest Group, a wireless universal serial bus, USB, transceiver 70 and/or the like. The Bluetooth™ transceiver 68 may be capable of operating according to low power or ultra-low power Bluetooth™ technology, for example, Wibree™, radio standards. In this regard, the apparatus 10 and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the mobile terminal. For example, the memories may comprise an identifier, such as an international mobile equipment identification, IMEI, code, capable of uniquely identifying apparatus 10.

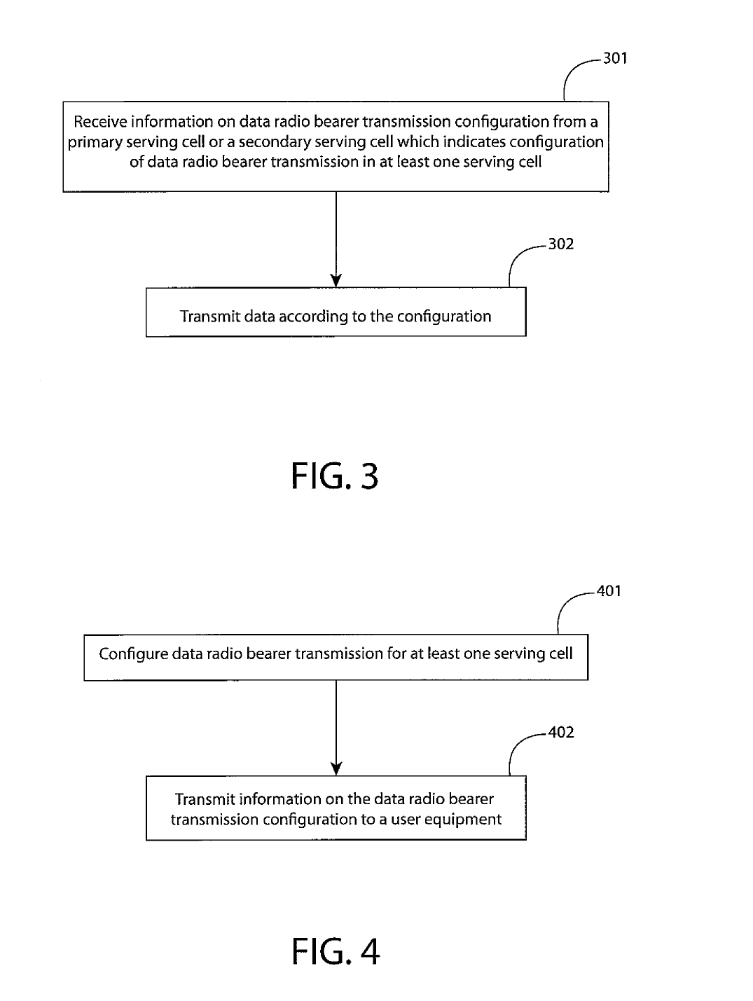

FIG. 3 is a flow chart illustrating an example method for data radio bearer configuration in a heterogeneous network in accordance with an example embodiment of the invention. Example method 300 may be performed by or in an apparatus, such as the apparatus 10 of FIG. 2.

At block 301, the apparatus receives information on data radio bearer transmission configuration from a primary serving cell or a secondary serving cell such as, for example, a serving cell served by the marco eNB or a serving cell served by the small cell eNB of FIG. 1. In an example embodiment, the information on data radio bearer transmission configuration indicates configuration of data radio bearer transmission in a secondary serving cell. In another example embodiment, the information on data radio bearer transmission configuration indicates configuration of data radio bearer transmission in a plurality of secondary serving cells to increase the data throughput. In yet another example embodiment, the information on data radio bearer transmission configuration indicates configuration of data radio bearer transmission in a primary serving cell.

In an example embodiment, the information on data radio bearer transmission configuration is received when the apparatus enters into dual connectivity mode from macro cell's single connectivity mode. The primary serving cell may decide to offload or redirect one or more existing DRBs to one or more secondary serving cells in the small cell layer. The offloading or redirecting may be based at least in part on the QoS characteristics of data traffic. The offloading or redirecting may be based at least in part on the radio condition of primary serving cell and the radio condition of one or more secondary cells. In another example embodiment, the information on data radio bearer transmission configuration is received when the apparatus is in dual connectivity mode and the primary serving cell decides to offload or redirect at least one of existing data radio bearers to one or more secondary serving cells. The offloading or redirecting may be based at least in part on QoS characteristics of data traffic. The offloading or redirecting may be based at least in part on the radio condition of primary serving cell and the radio condition of one or more secondary cells. In yet another embodiment, the information on data radio bearer transmission configuration is received when the apparatus is in dual connectivity mode and the primary serving cell or the secondary serving cell decides to set up at least one new data radio bearer in one or more secondary serving cells.

In an example embodiment, the information on data radio bearer configuration comprises an indicator which indicates whether the data radio bearer transmission is configured for the at least one serving cell. If the indicator indicates the data radio bearer transmission is not configured for the at least one serving cell, then there is no preference of data radio bear transmission on any serving cells. If the indicator indicates the data radio bearer transmission is configured for the at least one serving cell, then the information on data radio bearer transmission configuration may further comprise one or more cell indexes of the at least one serving cell. The information on data radio bearer transmission configuration may also comprise a second indicator which indicates whether the data radio bearer transmission is prioritized on the one or more serving cells indicated by the one or more cell indexes, or data radio bearer transmission is designated only on the one or more serving cells indicated by the one or more cell indexes. For example, if the information on configuration comprises a cell index, then the second indicator indicates the data radio bearer configuration is prioritized or designated on a serving cell which is indicated by the cell index. In another example, if the information on configuration comprises two cell indexes, then the second indicator indicates the data radio bearer configuration is prioritized or designated on two serving cells which are indicated by the two cell indexes. In an example embodiment, if the second indicator indicates the data radio bearer transmission is prioritized on the one or more serving cells indicated by the one or more cell indexes, the apparatus prioritizes data transmission on the one or more serving cells which are indicated by the one or more cell indexes. If the one or more serving cells indicated by the cell indexes are not available, the apparatus may transmit data to other serving cells. In an example embodiment, if the second indicator indicates the data radio bearer transmission is designated only on the one or more serving cells indicated by the one or more cell indexes, the apparatus designates data transmission on the one or more serving cells which are indicated by the one or more cell indexes. If the one or more serving cells indicated by the one or more cell indexes are not available, no data is sent by the apparatus.

In another example embodiment, a DRB space is reserved to indicate the DRBs assigned to the at least one serving cell. For example, the highest N (N is an integer and may be communicated between network and the apparatus) DRB indexes are reserved for the at least one serving cell. When a DRB within the reserved space is received, the apparatus is aware that data for the DRB will be transmitted to the at least one serving cell.

In an example embodiment, the information on data radio bearer transmission configuration is received through a radio resource control (RRC) dedicated signaling. In an example embodiment, the information is carried in a data radio bearer add or modify message in the radio resource control message.

In an example embodiment, after the apparatus receives the information on data radio bearer configuration and the information indicates that at least one DRB is established in the at least one serving cell, the apparatus allocate data from the at least one DRB in a separate buffer which is specific for transmission in the at least one serving cell.

At block 302, the apparatus transmit data according to the configuration. In an example embodiment, the data is transmitted based on a scheduling command (e.g. PDCCH) from a secondary serving cell. In another embodiment, the data is transmitted based on a scheduling command (e.g. PDCCH) from a primary serving cell.

FIG. 4 is a flow diagram illustrating an example method for data radio bearer configuration in a heterogeneous network in accordance with another example embodiment of the invention. Example method 400 may be performed by or in an apparatus, such as the macro eNB or the small cell eNB of FIG. 1.

At block 401, the apparatus configures data radio bearer transmission for at least one serving cell. In an example embodiment, the data radio bearer transmission is configured when a UE enters into dual connectivity mode. In another example embodiment, the data radio bearer transmission is configured when a UE is in dual connectivity mode and the apparatus decides to offload or redirect at least one of existing data radio bearers to one or more secondary serving cells. In yet another embodiment, the data radio bearer transmission is configured when a UE is in dual connectivity mode and the apparatus decides to set up at least one new data radio bearer in one or more secondary serving cells.

At block 402, the apparatus transmit information on the data radio bearer transmission configuration. The information on data radio bearer transmission configuration is described in the description section of FIG. 3. The information on the data radio bearer transmission configuration may be transmitted via a radio resource control message. The information on the data radio bearer transmission configuration may be further carried on a data radio bearer add or modify message in the radio resource control message.

Without in any way limiting the scope, interpretation, or application of the claims appearing below, a technical effect of one or more of the example embodiments disclosed herein may be enabling data radio bearer transmission under dual connectivity in a heterogeneous network.

Embodiments of the present invention may be implemented in software, hardware, application logic or a combination of software, hardware and application logic. The software, application logic and/or hardware may reside on an electronic device or a personal key. If desired, part of the software, application logic and/or hardware may reside on an electronic device and part of the software, application logic and/or hardware may reside on a personal key. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium, for example a non-transitory computer-readable storage medium, that may be any media or means that can contain or store the instructions for use by or in connection with an instruction execution system, apparatus, or device.

If desired, the different functions discussed herein may be performed in a different order and/or concurrently with each other. Furthermore, if desired, one or more of the ssabove-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-24. (canceled)

25. A method, comprising:
receiving, by a user equipment, information on data radio bearer transmission configuration from a primary serving cell or a secondary serving cell which indicates configuration of data radio bearer transmission in at least one serving cell; and
transmitting data according to the configuration.

26. The method of claim 25, wherein the information on data radio bearer transmission configuration is received when at least one of the following events occurs: the user equipment enters into dual connectivity mode, the user equipment is in dual connectivity mode and the primary serving cell decides to offload or redirect at least one of existing data radio bearers to the at least one serving cell, and the user equipment is in dual connectivity mode and the primary serving cell or the secondary serving cell decides to set up at least one new data radio bearer in the at least one serving cell.

27. The method of claim 25, wherein the information on data radio bearer transmission configuration is received via a radio resource control message.

28. The method of claim 25, wherein the information on data radio bearer configuration comprises an indicator which indicates whether the data radio bearer transmission is configured for the at least one serving cell.

29. The method of claim 28, wherein if the indicator indicates the data radio bearer transmission is not configured for the at least one serving cell, then there is no preference of data radio bear transmission on any serving cells.

30. The method of claim 28, wherein if the indicator indicates the data radio bearer transmission is configured for the at least one serving cell, then the information on data radio bearer transmission configuration further comprises one or more cell indexes of the at least one serving cell and a second indicator which indicates whether data radio bearer transmission is prioritized on the one or more serving cells indicated by the one or more cell indexes or data radio bearer transmission is designated only on the one or more serving cells indicated by the one or more cell indexes.

31. The method of claim 25, wherein the information is received in a data radio bearer add or modify message, and the data radio bearer add or modify message is received in a radio resource control message.

32. The method of claim 25, wherein the data radio bearer transmission is based at least in part on a scheduling command from the primary serving cell or the secondary serving cell.

33. The method of claim 25, wherein the primary serving cell and the secondary serving cell are served by different base stations.

34. An apparatus, comprising:
at least one processor; and
at least one memory including computer program code,
wherein the at least one memory and the computer program code are configured to, with the at least one processor, cause the apparatus to perform at least the following:
receive information on data radio bearer transmission configuration from a primary serving cell or a secondary serving cell which indicates configuration of data radio bearer transmission in at least one serving cell; and
transmit data according to the configuration.

35. The apparatus of claim 34, wherein the information on data radio bearer transmission configuration is received when at least one of the following events occurs: the apparatus enters into dual connectivity mode, the apparatus is in dual connectivity mode and the primary serving cell decides to offload or redirect at least one of existing data radio bearers to the at least one serving cell, and the apparatus is in dual connectivity mode and the primary serving cell or the secondary serving cell decides to set up at least one new data radio bearer in the at least one serving cell.

36. The apparatus of claim 34, wherein the information on data radio bearer transmission configuration is received via a radio resource control message.

37. The apparatus of claim 34, wherein the information on data radio bearer configuration comprises an indicator which indicates whether the data radio bearer transmission is configured for the at least one serving cell.

38. The apparatus of claim 34, wherein if the indicator indicates the data radio bearer transmission is not configured for the at least one serving cell, then there is no preference of data radio bear transmission on any serving cells.

39. The apparatus of claim 34, wherein if the indicator indicates the data radio bearer transmission is configured for the at least one serving cell, then the information on data radio bearer transmission configuration further comprises one or more cell indexes of the at least one serving cell and a second indicator which indicates whether data radio bearer transmission is prioritized on the one or more serving cells indicated by the one or more cell indexes or data radio bearer transmission is designated only on the one or more serving cells indicated by the one or more cell indexes.

40. The apparatus of claim 34, wherein the information is received in a data radio bearer add or modify message, and the data radio bearer add or modify message is received in a radio resource control message.

41. The apparatus of claim 34, wherein the data radio bearer transmission is based at least in part on a scheduling command from the primary serving cell or the secondary serving cell.

42. The apparatus of claim 34, wherein the primary serving cell and the secondary serving cell are served by different base stations.

43. An apparatus, comprising:
at least one processor; and
at least one memory including computer program code,
wherein the at least one memory and the computer program code are configured to, with the at least one processor, cause the apparatus to perform at least the following:
configure data radio bearer transmission for at least one serving cell; and
transmit information on the data radio bearer transmission configuration to a user equipment.

44. The apparatus of claim 43, wherein the information on data radio bearer configuration comprises an indicator which indicates whether the data radio bearer transmission is configured for the at least one serving cell.
